(19) United States
(12) Patent Application Publication
(10) Pub. No.: US 2016/0257039 A1
(43) Pub. Date: Sep. 8, 2016

(54) MOLDING DEVICE AND METHOD OF MANUFACTURING RESIN MEMBER

(71) Applicant: TOYOTA JIDOSHA KABUSHIKI KAISHA, Toyota-shi, Aichi-ken (JP)

(72) Inventor: Yoshihiro IWANO, Toyota-shi (JP)

(73) Assignee: TOYOTA JIDOSHA KABUSHIKI KAISHA, Toyota-shi, Aichi-ken (JP)

(21) Appl. No.: 15/030,792

(22) PCT Filed: Sep. 26, 2014
(86) PCT No.: PCT/JP2014/075713

§ 371 Date: Apr. 20, 2016

(30) Foreign Application Priority Data
Oct. 28, 2013 (JP) 2013-223385

(51) Int. Cl. B29C 43/56; B29C 43/52; B29C 43/02; B29C 43/36; B29C 33/10; B29C 33/42

(52) U.S. Cl. CPC B29C 43/56; B29C 33/10; B29C 33/42; B29C 43/021; B29C 43/36; B29C 43/52; B29K 2101/12

(57) ABSTRACT

First passages are formed, so as to be continuous with bottom portions of first concave portions for vertical rib molding, at a concave portion for rib molding of a first molding die. A suction section that sucks interiors of the first passages is connected to the first passages. Further, second passages that dead-end are formed, so as to be continuous with bottom portions of second concave portions for rib molding, at the concave portion for rib molding of the first molding die. In a molding step, the first molding die and a second molding die are closed, and interiors of the first passages are sucked by the suction section, and some of a thermoplastic resin material is made to flow-in to as far as the first passages and the second passages, and the thermoplastic resin material is molded.

### TECHNICAL FIELD

The present invention relates to a molding device and to a method of manufacturing a resin member.

### BACKGROUND ART

Methods of molding a thermoplastic resin material in molding dies and making the thermoplastic resin material into a resin member are known (see, for example, Patent Document 1 through Patent Document 3).

### PRIOR ART DOCUMENTS

### Patent Documents

[Patent Document 1] Japanese Patent Application Laid-Open (JP-A) No. 2003-39540
[Patent Document 2] JP-A No. H8-183046
[Patent Document 3] JP-A No. 2001-191419

### SUMMARY OF INVENTION

### Technical Problem

However, there is room for improvement in moldability in cases in which ribs are formed by molding a heated thermoplastic resin material between molding dies.

In view of the above-described circumstances, an object of the present invention is to provide a molding device and a method of manufacturing a resin member that can improve moldability in a case in which ribs are formed by molding a heated thermoplastic resin material between molding dies.

### Solution to Problem

A molding device relating to a first aspect of the present invention comprises: a first molding die at whose molding surface are formed concave portions for rib molding; and a second molding die that is disposed so as to face the molding surface side of the first molding, die, and that nips, between the second molding die and the first molding die, a thermoplastic resin material that has been preheated or while heating the thermoplastic resin material, wherein the first molding die has a first passage that is continuous with a bottom portion of the concave portion for rib molding, and that communicates with an internal space of that concave portion for rib molding, and that is connected to a suction section, and whose passage interior is sucked by the suction section, and a second passage that dead-ends, and that is continuous with a bottom portion of the concave portion for rib molding, and that communicates with an internal space of that concave portion for rib molding.

In accordance with the above-described structure, concave portions for rib molding are formed in the molding surface of the first molding die, and the second molding die nips, between itself and the first molding die, the thermoplastic resin material that has been preheated or while heating the thermoplastic resin material. Due thereto, the thermoplastic resin material flows into the interiors of the concave portions for rib molding.

Here, the first molding die has the first passage and the second passage. The first passage is continuous with the bottom portion, of the concave portion for rib molding, and communicates with the internal space of that concave portion for rib molding, and is connected to a suction section, and the passage interior of the first passage, is sucked by the suction section. Therefore, due to the suction section sucking the first passage interior, gas, that is generated from the thermoplastic resin material due to heating, flows-out into the first passage, and the flowing of the thermoplastic resin material into the concave portion for rib molding is promoted. Further; the second passage is a passage that dead-ends, and is continuous with the bottom portion of the concave portion for rib molding, and communicates with the internal space of that concave portion for rib molding. Therefore, when the thermoplastic resin material flows into the concave portion for molding that communicates with the second passage, gas, that is generated from the thermoplastic resin material due to heating, flows-out into the second passage. For these reasons, the thermoplastic resin material is filled well into the interiors of the concave portions for rib molding. Further, as compared with the case of setting the first passage and the suction section, the second passage can be set in a narrow range, and therefore, can be set more densely (e.g., a large number at a narrow interval) even at a limited range of the first molding die.

In a second aspect of the present invention, in the molding device relating to the first aspect, a plurality of the first passages are set, and the second passage is set at a region between the plurality of the first passages.

In accordance with the above-described structure, the second passage is set at a region between the plural first passages. Therefore, when the suction section sucks the first passage interiors, at the thermoplastic resin material, both sides of the portion that faces the second passage are sucked into the concave portions for rib molding. Accompanying this, when force, that makes the thermoplastic resin material start to flow toward the molding surface side of the first molding die, is applied to the portion, that faces the second passage, of the thermoplastic resin material and the surrounding portions thereof, the portion, that faces the second passage, of the thermoplastic resin material and the surrounding portions thereof also easily flow into the interiors of the concave portions for rib molding.

A method of manufacturing a resin member relating to a third aspect of the present invention comprises, by using the molding device relating to the first aspect or the second aspect a placement step of placing a thermoplastic resin material between the first molding die and the second molding die; and a molding step of after the placement step, closing the first molding die and the second molding die, and pressurizing the thermoplastic resin material that has been preheated or while heating the thermoplastic resin material, and sucking an interior of the first passage by the suction section, and molding the thermoplastic resin material.

In accordance with the above-described structure, in the placement step, a thermoplastic resin material is placed between the first molding die and the second molding die. In the molding step that is after the placement step, the first molding die and the second molding die are closed, the thermoplastic resin material that has been preheated is pressurized or the thermoplastic resin material is pressurized while being heated, and the first passage interior is sucked by the suction section, and the thermoplastic resin material is molded. Therefore, gas, that is generated from the thermoplastic resin material due to the heating, flows-out into the first passage and the second passage, and the thermoplastic resin material is filled well into the interiors of the concave portions for rib molding.

A method of manufacturing a resin member relating to a fourth aspect of the present invention comprises: a placement step of placing a thermoplastic resin material between a first molding die, in whose molding surface are formed concave portions for rib molding and that has a passage formed so as to be continuous with a bottom portion of the concave portion for rib molding and communicating with an internal space of that concave portion for rib molding, and a second molding die that is disposed so as to face the molding surface side of the first molding die; a molding step of after the placement step, closing the first molding die and the second molding die, and pressurizing the thermoplastic resin material that has been preheated or while heating the thermoplastic resin material, and causing some of the thermoplastic resin material to flow-in to as far as the passage, and molding the thermoplastic resin material; and a cutting step of after the molding step, cutting a region that has been molded due to some of the thermoplastic resin material having flowed-into the passage.

In the above-described structure, in the placement step, a thermoplastic resin material is placed between the first molding die, in whose molding surface are formed concave portions for rib molding and that has a passage formed so as to be continuous with the bottom portion of the concave portion for rib molding and communicating with the internal space of that concave portion for rib molding, and a second molding die that is disposed so as to face the molding surface side of the first molding die. In the molding step that is after the placement step, the first molding die and the second molding die are closed, the thermoplastic resin material that has been preheated is pressurized or the thermoplastic resin is pressurized while being heated, and some of the thermoplastic resin material is made to flow-in to as far as the passage, and the thermoplastic resin material is molded. Therefore, gas, that is generated from the thermoplastic resin material due to the heating, is made to flow-out into the passage, and the thermoplastic resin material is filled well into the interiors of the concave portions for rib molding. In the cutting step that is after the molding step, the region, that has been molded due to some of the thermoplastic resin material having flowed-into the passage, is cut.

### Advantageous Effects of Invention

As described above, the present invention has the excellent effect of being able to improve the moldability in a case in which ribs are formed by molding, between molding dies, a thermoplastic resin material that is heated.

### BRIEF DESCRIPTION OF DRAWINGS

FIG. 1 is a front view showing a door panel, that has been manufactured by a method of manufacturing a resin member by using a molding device relating to an embodiment of the present invention, in a state of being seen from a door inner surface side.

FIG. 2 is a plan view showing a first molding die, that is applied to the molding device relating to the embodiment of the present invention, in a state of being seen from a molding surface side.

FIG. 3 is a vertical sectional view showing the first molding die, that is equipped with first concave portions for rib molding and first passages and the like, together with a second molding die and a thermoplastic resin material and the like.

FIG. 4 is a vertical sectional view showing the first molding die, that is equipped with second concave portions for rib molding and second passages, together with the second molding die and the thermoplastic resin material and the like.

FIG. 5A is a schematic sectional view for explaining a molding step of the method of manufacturing a resin member relating to the embodiment of the present invention, and shows a state in which some of the thermoplastic resin material has flowed-in into the first concave portion for rib molding.

FIG. 5B is a schematic sectional view for explaining the molding step of the method of manufacturing a resin member relating to the embodiment of the present invention, and shows a state in which some of the thermoplastic resin material has flowed-in to as far as the first passage.

FIG. 6A is a schematic sectional view for explaining a cutting step of the method of manufacturing a resin member relating to the embodiment of the present invention, and shows a state before the cutting step.

FIG. 6B is a schematic sectional view for explaining the cutting step of the method of manufacturing a resin member relating to the embodiment of the present invention, and shows a state after cutting.

### DESCRIPTION OF EMBODIMENTS

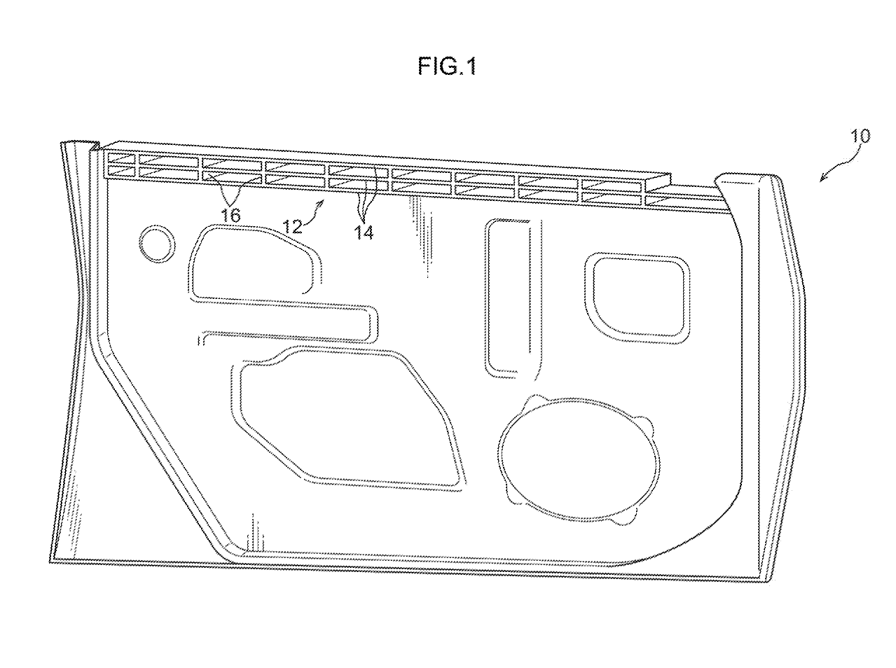

A molding device and a method of manufacturing a resin member relating to an embodiment of the present invention are described by using FIG. 1 through FIG. 6B.

(Summary of Resin Member)

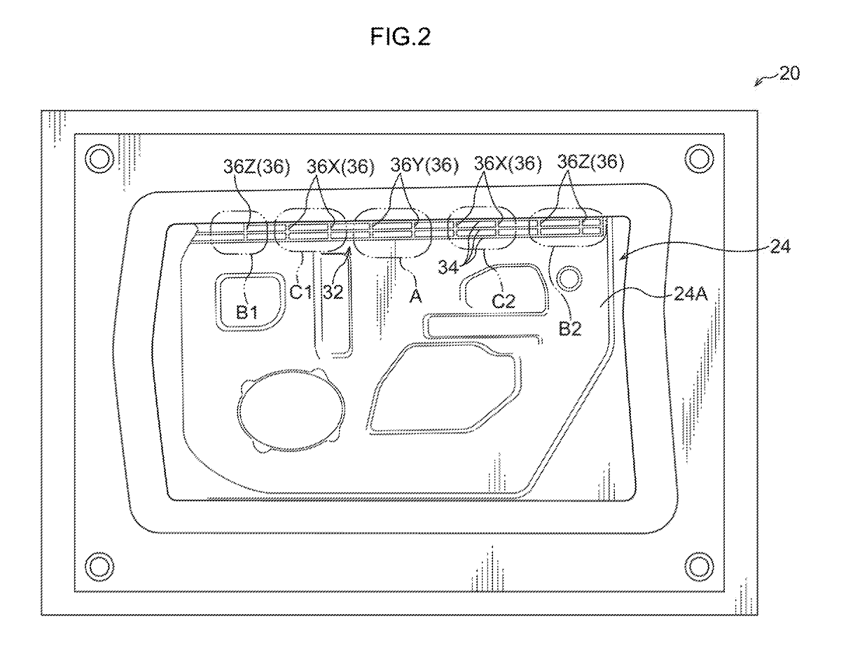

A door panel 10 for a vehicle that serves as a resin member is shown in FIG. 1 in a front view seen from the door inner surface side. This door panel 10 is manufactured by a method of manufacturing a resin member that is described later, by using a molding device 20 (see FIG. 2 through FIG. 4) relating to the present embodiment. The door panel 10 structures a side door of a vehicle, and is disposed at a vehicle side portion. A rib 12 that is formed in a lattice shape is formed at the upper portion of the door panel 10. The rib 12 has lateral ribs 14 and vertical ribs 16. The lateral ribs 14 and the vertical ribs 16 project-out in the door thickness direction (toward the vehicle transverse direction inner side in the state in which the door is closed). The lateral ribs 14 extend in the door transverse direction (the vehicle longitudinal direction in the state in which the door is closed), and a plurality of the lateral ribs 14 are formed so as to be lined-up in the door vertical direction. In contrast, the vertical ribs 16 extend in the door vertical direction and a plurality of the vertical ribs 16 are formed so as to be lined-up in the door transverse direction.

(Structure of Molding Device)

A first molding die 24 applied to the molding device 20 relating to the present embodiment is shown in FIG. 2 in a plan view seen from a molding surface 24A side of the first molding die 24. As shown in FIG. 2, a concave portion 32 for rib molding, that is lattice-shaped and is for molding the rib 12 (see FIG. 1), is formed in the molding surface 24A of the first molding die 24. The concave portion 32 for rib molding has plural concave portions 34 for lateral rib molding that are formed so as to be lined-up for molding the lateral ribs 14 (see FIG. 1), and plural concave portions 36 for vertical rib molding that are formed so as to be lined-up for molding the vertical ribs 16 (see FIG. 1).

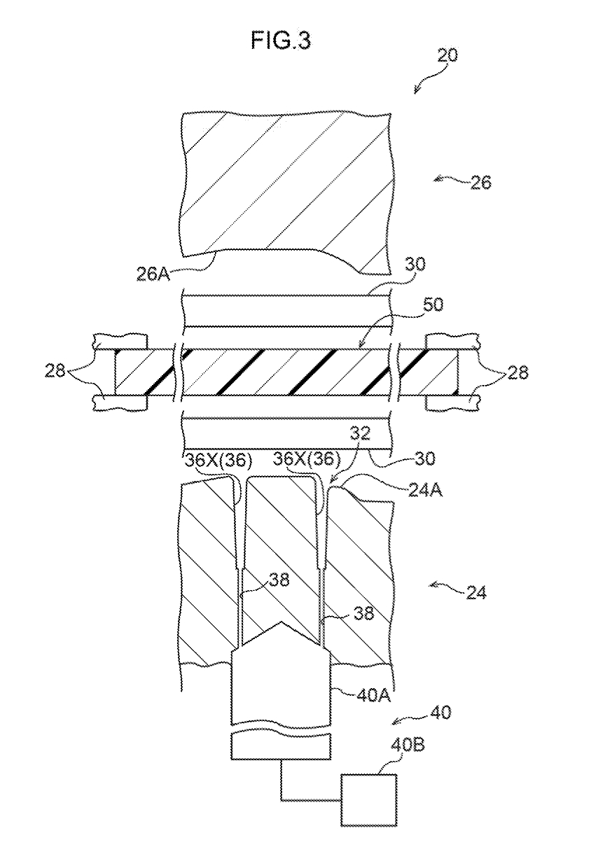

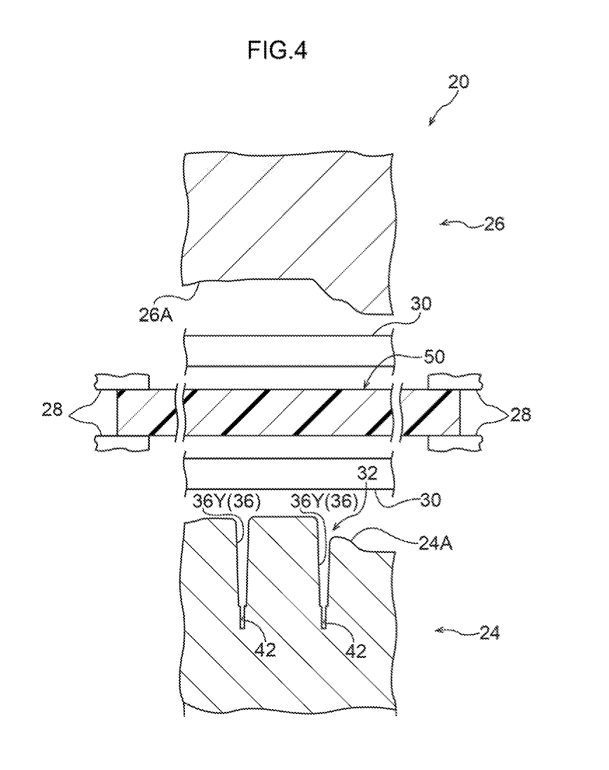

Vertical sectional views showing portions of the first molding die 24, and the like, are shown in FIG. 3 and FIG. 4. As shown in FIG. 3, the molding device 20 has a second molding die 26 that is disposed so as to face the molding surface 24A side of the first molding die 24. The first molding die 24 and the second molding die 26 are supported so as to be able to move in the device vertical direction (in directions of approaching and moving away from one another), by unillustrated raising/lowering devices respectively. A thermoplastic resin material 50, that is sheet-shaped (plate-shaped) and that has been preheated, is nipped between the first molding die 24 and the second molding die 26.

More concretely, the molding device 20 has clamps 28 shown schematically in the drawings) for nipping the end portions of the thermoplastic resin material 50, and has heaters 30 (shown schematically in the drawings) for heating the thermoplastic resin material 50. As an example, the clamps 28 are known clamps that are provided as top/bottom pairs at the left and right both sides of the first molding die 24 and the second molding die 26, and hold the thermoplastic resin material 50 between the first molding die 24 and the second molding die 26. Further, as an example, the heaters 30 are halogen heaters that are supported so as to be able to be disposed at the obverse and reverse both sides of the thermoplastic resin material 50, and so as to be able to be withdrawn from the obverse and reverse both sides of the thermoplastic resin material 50.

For example, polyamide, polyolefin (e.g., polypropylene), and the like can be applied as the resin of the thermoplastic resin material 50. Further, the thermoplastic resin material 50 of the present embodiment is structured by a composite material that is formed by fibers (e.g., glass fibers or carbon fibers) being solidified in a thermoplastic resin, i.e., a fiber reinforced resin (FRP). Note that fiber reinforced resins have the features that the strength thereof is high and the fluidity thereof at the time of molding is poor, as compared with resins that do not contain reinforcing fibers.

First passages 38 (tunnel portions), that are continuous with the bottom portions of first concave portions 36X for vertical rib molding, that are any (some) of the plural concave portions 36 for vertical rib molding, and that communicate with the interior spaces of these first concave portions 36X for vertical rib molding, are formed in the first molding die 24, One end side of a vacuum tube 40A, that structures a portion of a suction section 40, is connected to the first passages 38. The other end side of the vacuum tube 40A is connected to a vacuum suction device 4013 (shown as a block in the drawings) that structures a portion of the suction section 40. The suction section 40 sucks the interiors of the first passages 38 due to the vacuum suction device 40B operating in a case in which the first molding die 24 and the second molding die 26 are closed. Note that the first concave portions 36X for vertical rib molding are melons at which it is highly difficult to mold ribs, among the plural concave portions 36 for vertical rib molding, and are structured so as to communicate with the suction section 40 via the first passages 38 in order to facilitate rib molding.

As shown in FIG. 4, second passages 42, that dead-end and that are continuous with the bottom portions of second, concave portions 36Y for vertical, rib molding, that are any others (some others) of the plural concave portions 36 for vertical rib molding, and that communicate with the interior spaces of these second concave portions 36Y for vertical rib molding, are formed in the first molding die 24. Note that dead-end here means that only the bottom portion side of the second concave portion 36Y for vertical rib molding is open, and the second concave portion 36Y for vertical rib molding, ends at the distal end side of the passage that communicates with this opening (in the present embodiment, the distal end side of the passage that extends in the direction of moving away from the internal space of the second concave portion 36Y for vertical rib molding). The second concave portions 36Y for vertical rib molding are regions that have the next highest difficulty of rib molding, after the first concave portions 36X for vertical rib molding (see FIG. 3), among the plural concave portions 36 for vertical rib molding, and are structured so as to communicate with the second passages 42 in order to facilitate rib molding. Further, as compared with the case of setting the first passages 38 and the suction section 40 shown in FIG. 3, the second passages 42 can be set in a narrow range, and therefore, the second passages 42 can be set densely (e.g., a large number at a narrow interval) even at the limited range of the first molding die 24 that is shown in FIG. 4.

As shown in FIG. 2, the plural first concave portions 36X for vertical rib molding (and the first passages 38 (see FIG. 3)) are set, and are formed at region C1 that is at the door front side of the door longitudinal direction intermediate portion and region C2 that is at the door rear side of the door longitudinal direction intermediate portion. The second concave portions 36Y for vertical rib molding are formed at region A of the door longitudinal direction central portion, and are set between the region C1 and the region C2 that are the formation regions of the plural first concave portions 36X for vertical rib molding. In other words, the second passages 42 that are shown in FIG. 4 are set at the region between the plural first passages 38 (see FIG. 3). Moreover, of the plural concave portions 36 for vertical rib molding that are shown in FIG. 2, third concave portions 36Z for vertical rib molding, that are not connected to the first passages 38 (see FIG. 3) and are not connected to the second passages 42 (see FIG. 4) as well, are set at region 131 of the door front side end portion and region B2 of the door rear side end portion. As compared with the first concave portions 36X for vertical rib molding and the second concave portions 36Y for vertical rib molding, the third concave portions 36Z for vertical rib molding are regions where rib molding is relatively easy. Further, in the present embodiment, as an example, the plural concave portions 34 for lateral rib molding are not connected to passages that correspond to the first passages 38 (see FIG. 3) nor to passages that correspond to the second passages 42 (see FIG. 4).

(Method of Manufacturing Resin Member and Operation/Effects)

Operation and effects of the present embodiment are described next while describing a method of manufacturing the resin member (the door panel 10) using the molding device 20.

First, in a placement step, the thermoplastic resin material 50 is placed between the first molding die 24 and the second molding die 26 that are shown in FIG. 3. Concretely, the thermoplastic resin material 30 is placed between the first molding die 24 and the second molding die 26, and the thermoplastic resin material 50 is held by the clamps 28. Next, in a heating step that is after the placement step, the thermoplastic resin material 50 is heated. Concretely, the heaters 30 are disposed at the obverse and reverse surface sides of the thermoplastic resin material 50, and the thermoplastic resin material 50 is heated by the heaters 30. Due thereto, the thermoplastic resin material 50, that is disposed between the first molding die 24 and the second molding die 26, is heated. After the heaters 30 heat the thermoplastic resin material 50, the heaters 30 are withdrawn from the obverse and reverse surface sides of the thermoplastic resin material 50.

In a molding step that is after the placement step and the heating step, the first molding die 24 and the second molding die 26 are closed, and the thermoplastic resin material 50 that has been preheated is pressurized, and the first passage 38 interiors are sucked by the suction section 40, and portions of the thermoplastic resin material 50 are made to flow into the first passages 38 and the second passages 42 (see FIG. 4), and the thermoplastic resin material 50 is molded. Concretely, first, due to the first molding die 24 being raised by an unillustrated raising/lowering device and the second molding die 26 being lowered by an unillustrated raising/lowering device, the first molding die 24 and the second molding die 26 are closed, and the thermoplastic resin material 50 is pressed from the obverse and reverse both sides. Then, the vacuum suction device 408 of the suction section. 40 is operated, and the air within the first passages 38 is sucked via the vacuum tube 40A.

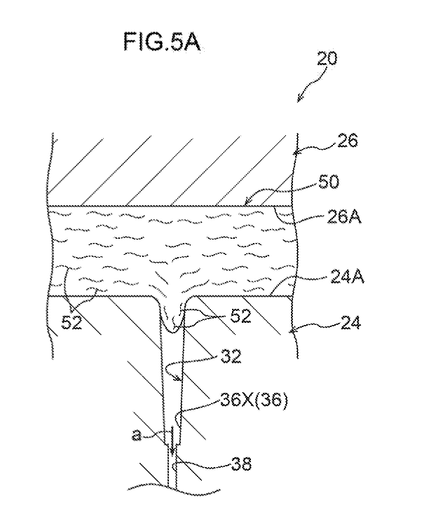

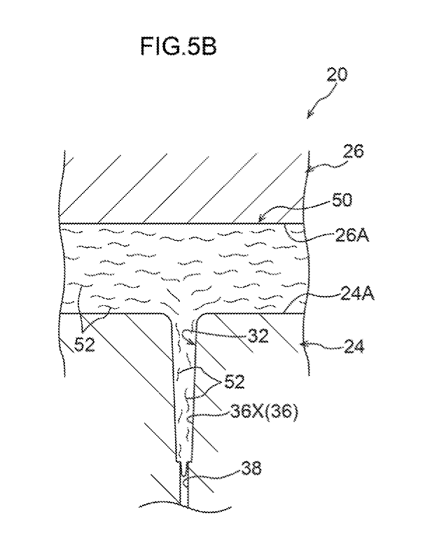

Schematic sectional views for explaining the molding step are shown in FIG. 5A and FIG. 5B. Due to the interior of the first passage 38, that communicates with the first concave portion 36X for vertical rib molding shown in FIG. 5A, being sucked by the suction section 40 (see FIG. 3), gas within the first concave portion 36X for vertical rib molding is sucked to the first passage 38 side (refer to the arrow a direction), and flowing of the thermoplastic resin material 50 into the first concave portion 36X for vertical rib molding is promoted. Therefore, even if gas is generated, from the thermoplastic resin material 30 due to heating (or, in a case in Which a plurality of the thermoplastic resin materials 50 are superposed one on another, even if gas comes-out from between these materials), and further, even if the thermoplastic resin material 50 contains reinforcing fibers 52, some of the thermoplastic resin material 50 flows into the first concave portion 36X for vertical rib molding in a state in which the reinforcing fibers 52 are contained. Then, due to the air within the first passage 38 continuing to be sucked toward the suction section 40 (see FIG. 3) side, as shown in FIG. 5B, some of the thermoplastic resin material 50 flows-in to as far as the first passage 38 interior In other words, gas, that is generated from the thermoplastic resin material 50, flows through the first passage 38 to the suction section 40 (see FIG. 3), and some of the thermoplastic resin material 50 is filled well into the interior of the first concave portion 36X for vertical rib molding in a state in which the reinforcing fibers 52 are contained.

Further, when the thermoplastic resin material 50 flows into the second concave portion 36Y for vertical rib molding that communicates with the second passage 42 shown in FIG. 4, gas, that is generated from the thermoplastic resin material 50 due to heating, flows-out into the second passage 42. Accordingly, the thermoplastic resin material 50 is filled well (in a state similar to the state shown in FIG. 5B) into the interior of the second concave portion 36Y for vertical rib molding that communicates with the second passage 42.

Namely, as in the present embodiment, even in the case of as structure in which the first passage 38 and the suction section 40 that are shown in FIG. 3 cannot be set per each of the concave portions 36 for vertical rib molding due to constraints on space because the plural concave portions 36 for vertical rib molding are formed adjacent to one another, by densely setting the second passages 42 (see FIG. 4) that dead-end and for which little space suffices, the thermoplastic resin material 50 is filled well even into the second concave portions 36Y for vertical rib molding that are not connected to the suction section 40.

Further, in the present embodiment, as shown in FIG. 2, the first concave portions 36X for vertical rib molding that communicate with the first passages 38 (see FIG. 3) are set at the door longitudinal direction both sides of the second concave portions 36Y for vertical rib molding that communicate with the second passages 42 (see FIG. 4). Therefore, when the suction section 40 shown in FIG. 3 sucks the interiors of the first passages 38, the thermoplastic resin material 50 is sucked into the first concave portions 36X for vertical rib molding that are at the door longitudinal direction both sides of the second concave portions 36Y for vertical rib molding that are shown in FIG. 2. Accompanying this, when force, that attempts to make the thermoplastic resin material 50 flow toward the molding surface 24A side of the first molding die 24, is applied to the portions of the thermoplastic resin material 50 that are positioned at the side facing the second concave portions 36Y for vertical rib molding that are shown in FIG. 4, the thermoplastic resin material 50 easily flows-in also into the interiors of the second concave portions 36Y for vertical rib molding.

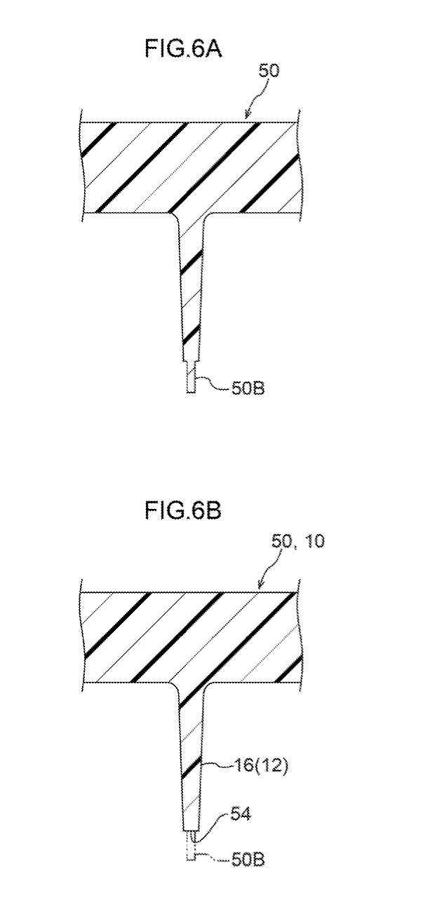

Due to the above, as shown in FIG. 5B, some of the thermoplastic resin material 50 is made to flow-in to as tar as the first passages 38 and the second passages 42 (see FIG. 4), while the thermoplastic resin material 50 is made to run along the molding surface 24A of the first molding die 24 and a molding surface 26A of the second molding die 26, and the thermoplastic resin material 50 is molded. Here, due to some of the thermoplastic resin material 50 flowing into the first passages 38 and the second passages 42 (see FIG. 4), regions that are molded in the shapes of projections, i.e., projecting portions 50B (see FIG. 6A), are formed.

After this molding step, the first molding die 24 shown in FIG. 3 is lowered by an unillustrated raising/lowering device, and the second molding die 26 is raised by an unillustrated raising/lowering device, and the thermoplastic resin material 50 that has been molded is released from the mold (removed from the mold) and cooled. In a cutting step thereafter, the projecting portion 50B, that is molded at a portion of the thermoplastic resin material 50 and is shown in FIG. 6A, is cut-off as shown in FIG. 6B. Note that, in FIG. 6B, the projecting portion 5013 before cutting is shown by the two-dot chain line. As an example, the projecting portion 50B can be cut (bent or cut) by a water jet or pliers or the like. The door panel 10 (see FIG. 1) is formed through the above-described steps, and, basically, traces of the cutting (or traces showing that reinforcing fibers and resin were sucked in the molding step) remain at an end surface 54 from which the projecting portion 50B (see FIG. 6A) has been cut.

As described above, in accordance with the present embodiment, by molding, the heated thermoplastic resin material 50 between the first molding, die 24 and the second molding die 26 that are shown in FIG. 3 and the like, the moldability in the case of forming the rib 12 (see FIG. 1) can be improved.

Further, in the present embodiment, because the first passage 38 interiors are sucked in the molding step by the suction section 40 shown in FIG. 3, the thermoplastic resin material 50 can be press-molded at a low applied pressure as compared with a comparative structure that does not have such a suction section 40. Further, even if the applied pressures at the time of molding were made to be equal in the present embodiment and the aforementioned comparative structure, the present embodiment could mold ribs of higher heights and ribs of shapes that are more difficult to mold, and the like. Namely, in accordance with the present embodiment, the degrees of freedom in setting the height of the ribs and in setting the shapes of the ribs also increase. Further, an increase in size of the device also can be suppressed due to it sulking for the applied pressure at the time of molding to be smaller than in the aforementioned comparative example.

Note that, to further discuss actual resin molding as supplemental description, injection molding is the mainstream method of actual resin molding. However, in injection molding, not only are large-scale equipment and expensive dies required, but also, at the time of molding, the dies are raised to a high temperature, and the temperature of the molded product after molding is lowered, and therefore, the cycle time is long. Further, because the resin material that is used in molding is a chip material, at the time of molding, the chip material must be melted in advance, and, to that end, a melting furnace is indispensable equipment. On the other hand, because the strength of the resin (e.g., polypropylene and polyamide and the like) by itself is low, in order to increase the strength of the resin material, there are cases in which the need to have the resin material contain reinforcing fibers, such as glass fibers or the like, arises, but, when reinforcing fibers are contained, the moldability deteriorates. Due to these circumstances, in fields in which high strength is required such as in vehicle bodies of automobiles or in aircraft or the like for example, molding of a fiber reinforced resin material is limited to the molding of thermosetting carbon fiber reinforced resin materials or the like. Namely, in such molding of a fiber reinforced resin material, the manufacturing cost is high, and in addition, a long time is required for molding, and therefore, in actuality, such molding of a fiber reinforced resin material can only address small-scale production.

In contrast, the present embodiment using a thermoplastic resin material contributes to a lowering of costs and to recycling, and further, because it is not injection molding in which a melted molding material is injected and filled into a cavity, shortening of the cycle time at the time of molding is possible, and, in addition, in accordance with the method of manufacturing a resin member using the molding device 20 relating to the present embodiment, good moldability can be ensured. Accordingly, the method of manufacturing a resin member that uses the molding device 20 relating to the present embodiment is advantageous also in terms of large-scale production.

### Supplementary Description of Embodiments

Note that the first concave portions 36X for vertical rib molding (the concave portions 36 for vertical rib molding that, are connected to the first passages 38 (see FIG. 3)), the second concave portions 36Y for vertical rib molding (the concave portions 36 fur vertical rib molding that are connected to the second passages 42 (see FIG. 4)), and the third concave portions 36Z for vertical rib molding (the concave portions 36 for vertical rib molding that are not connected to the first passages 38 (see FIG. 3) nor to the second passages 42 (see FIG. 4)) are set at any of the regions A, C1, C2, B1, B2 in accordance with the degree of difficulty of rib molding. Namely, the placement positions of the first concave portions 36X for vertical rib molding, the second concave portions 36Y for vertical rib molding, and the third concave portions 36Z for vertical rib molding are set in accordance with the clearance between the molding surface 24A of the first molding die 24 and the molding surface 26A of the second molding die 26 shown in FIG. 3 and FIG. 4, and the way by which the first molding die 24 and the second molding die 26 hit the thermoplastic resin material 50 (the timing of landing on the respective regions of the thermoplastic resin material 50 and the pressure applied to the respective regions of the thermoplastic resin material 50), and the shapes of the ribs to be molded, and the like.

For example, a case in which the first concave portions 36X for vertical rib molding or the third concave portions 36Z for vertical rib molding are set in region A of FIG. 2 also is possible. Further, a case in which the first concave portions 36X for vertical rib molding or the second concave portions 36Y for vertical rib molding are set in region B1 also is possible, and as case in which the first concave portions 36X for vertical rib molding or the second concave portions 36Y for vertical rib molding are set in region B2 also is possible. Moreover, a case in which the second concave portions 36Y for vertical rib molding or the third concave portions 36Z for vertical rib molding are set in region C1 also is possible, and a case in which the second concave portions 36Y for vertical rib molding or the third concave portions 36Z for vertical rib molding are set in region C2 also is possible.

Further, passages, that are similar to the first passages 38 (see FIG. 3) and the second passage 42 (see FIG. 4) of the above-described embodiment, may be connected respectively to the respective bottom portions of the three concave portions 34 for lateral rib molding that are for molding the lateral ribs 14 (see FIG. 1). In this case, the door longitudinal direction positions, at which passages that are similar to the first passages 38 (see FIG. 3) and the second passages 42 (see FIG. 4) are connected to the concave portions 34 for lateral rib molding, may be set in accordance with, for example, the door longitudinal direction positions at which the first passages 38 (see FIG. 3) and the second passages 42 (see FIG. 4) are connected to the concave portions 36 for vertical rib molding.

Further, as a modified example of the above-described embodiment, the first molding die may be a molding die at which plural concave portions for rib molding are formed at the molding surface thereof, in order to form plural ribs that are not continuous with one another In this case, there may be a structure in which the first passages are connected to any of the plural concave portions for rib molding, and the second passages are connected to any of the others of the plural concave portions for rib molding.

Further, in the above-described embodiment, the thermoplastic resin material 50 that is shown in FIG. 3 and the like is made to be a single plate material, but the thermoplastic resin material that is disposed between the first molding die and the second molding die may be a material in which plural plate materials are superposed one on another Further, in this case, the sizes of the plural plate materials may be different.

Further, in the heating step of the above-described, embodiment, the thermoplastic resin material 50 is heated by the heaters 30 that are halogen heaters, but the heating of the thermoplastic resin material may be carried out by another heating method such as, for example, heating by a heating furnace or the like. Further, in the above-described embodiment, the heating step is carried out after the placement step, but the heating step may be carried out before the placement step. Further, in the molding step, the first molding die and the second molding die may be closed and the thermoplastic resin material may be pressurized while being heated, without providing a heating step before the molding step. Namely, for example, there may be a structure in which heaters are provided at the respective molding surface sides of the first molding die and the second molding die, and the thermoplastic, resin material is nipped between the first molding die and the second molding die while being heated by these heaters.

Further, as a modified example of the above-described embodiment, a structure can be employed in which the second passages are not set at the region between the plural first passages, such as, for example, the first passages are set at the region between the plural second passages, or the like.

Further, the first molding die that is applied to the method of manufacturing a resin member relating to the fourth aspect of the present invention includes, for example, structures in which all of the passages that are continuous with the bottom portions of the concave portions for rib molding (the concave portions 36 for vertical rib molding) are made to be the first passages (38) (passages that are connected to the suction section (40)), and in addition, structures in which all of the passages that are continuous with the bottom portions of the concave portions for rib molding (the concave portions 36 for vertical rib molding) are the second passages (42).

Note that the above-described embodiment and above-described plural modified examples may be implemented by being combined together appropriately.

Although examples of the present invention have been described above, the present invention is not limited to the above, and, in addition to the above, can of course be implemented by being modified in various ways within a scope that does not depart from the gist thereof.

Note that the disclosure of Japanese Patent Application No. 2013-223385 is, in its entirety, incorporated by reference into the present specification.

1. A molding device comprising:
a first molding die, concave portions for rib molding being formed in a molding surface of the first molding die; and
a second molding die, the second molding die being disposed so as to face a molding surface side of the first molding die, and the second molding die nipping a preheated thermoplastic resin material or nipping the thermoplastic resin material while heating the thermoplastic resin material between the second molding die and the first molding die,
wherein the first molding die comprises:
a first passage, the first passage being continuous with a bottom portion of a respective concave portion for rib molding, the first passage communicating with an internal space of the respective concave portion for rib molding, the first passage being connected to a suction section, and a passage interior of the first passage being sucked by the suction section, and
a second passage, the second passage dead-ending, the second passage being continuous with a bottom portion of the respective concave portion for rib molding, and the second passage communicating with an internal space of the respective concave portion for rib molding.

2. The molding device of claim 1, wherein a plurality of the first passages are set, and the second passage is set at a region between the plurality of the first passages.

3. A method of manufacturing a resin member by using the molding device of claim 1, the method comprising:
placing a thermoplastic resin material between the first molding die and the second molding die; and
after the placing, molding the thermoplastic resin material, by closing the first molding die and the second molding die, pressurizing the thermoplastic resin material after the thermoplastic resin material has been preheated or while heating the thermoplastic resin material, and sucking an interior of the first passage by the suction section.

4. A method of manufacturing a resin member, comprising:
placing a thermoplastic resin material between a first molding die and a second molding die, concave portions for rib molding being formed in a molding surface of the first molding die and the first molding die comprising a passage formed so as to be continuous with a bottom portion of a respective concave portion for rib molding and communicating with an internal space of the respective concave portion for rib molding, and the second molding die being disposed so as to face a molding surface side of the first molding die;
after the placing, molding the thermoplastic resin material, by closing the first molding die and the second molding die, pressurizing the thermoplastic resin material after the thermoplastic resin material has been preheated or while heating the thermoplastic resin material, and causing some of the thermoplastic resin material to flow-in to as far as the passage; and
after the molding, cutting a region, the region having been molded due to some of the thermoplastic resin material having flowed-into the passage.
